(19) United States
(12) Patent Application Publication
(10) Pub. No.: US 2003/0023858 A1
(43) Pub. Date: Jan. 30, 2003

(54) Method for secure e-passports and e-visas

(75) Inventors: Dwip N. Banerjee, Austin, TX (US); Rabindranath Dutta, Austin, TX (US); Kamal Chandrakant Patel, Cedar Park, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/915,665

(22) Filed: Jul. 26, 2001

(51) Int. Cl. H04L 9/00

(52) U.S. Cl. 713/189; 713/175; 713/176

(57) ABSTRACT

A method, program, and system for creating and validating an electronic identification document are provided. The invention comprises providing an electronic document to a user, wherein the electronic document contains input fields for personal identification information, and receiving the user's personal identification information in the input fields of the electronic document. Next an electronic signature is received from the user and attached to the electronic document. An electronic certificate is added to the document, and the entire document is encrypted. The electronic document is then downloaded to a pervasive computing device, such as a PDA, palm pilot, or mobile phone. The electronic document acts as a legally valid form of identification, such as a passport. To validate the document, the document is uploaded from the pervasive computing device to an authorizing machine which decrypts the document. The digital certificate and electronic signature attached to the document are then verified for authenticity. After validation, the document is re-encrypted and downloaded back to the pervasive computing device.

### BACKGROUND OF THE INVENTION

1. Technical Field

The present invention relates generally to encrypted electronic documents, and more specifically to identification documents.

2. Description of Related Art

As modern society makes the transition toward a paperless design, it is important to support secure, paperless versions of forms and documents, using electronic representation mechanisms. In addition, pervasive computing devices such as cell phones, smart phones, palm pilots and Personal Digital Assistants (PDAs) are becoming more commonplace. As these devices proliferate, functional attributes of these devices will begin to replace the actions accompanying traditional paper versions of identifications such as passports. Their built-in ability to allow fast, secure digital verification, validation, authentication, and authorization makes them ideal platforms for introducing secure, electronic identification documents.

Therefore, it would be desirable to have a method for providing secure electronic identification documents, which are functionally and legally equivalent to traditional paper documents (e.g. passports), and can be downloaded to pervasive computing devices such as cell phones and PDAs.

### SUMMARY OF THE INVENTION

The present invention provides a method, program, and system for creating and validating an electronic identification document. The invention comprises providing an electronic document to a user, wherein the electronic document contains input fields for personal identification information, and receiving the user's personal identification information in the input fields of the electronic document. Next an electronic signature is received from the user and attached to the electronic document. An electronic certificate is added to the document, and the entire document is encrypted. The electronic document is then downloaded to a pervasive computing device, such as a PDA, palm pilot, or mobile phone. The electronic document acts as a legally valid form of identification, such as a passport.

To validate the document, the document is uploaded from the pervasive computing device to an authorizing machine which decrypts the document. The digital certificate and electronic signature attached to the document are then verified for authenticity. After validation, the document is re-encrypted and downloaded back to the pervasive computing device.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4A depicts a diagram illustrating a mobile phone in accordance with a preferred embodiment of the present invention;

FIG. 4B depicts a block diagram illustrating the hardware configuration of a mobile phone in accordance with a preferred embodiment of the present invention;

FIG. 5A depicts a diagram of a client in the form of a personal digital assistant (PDA) in accordance with a preferred embodiment of the present invention;

FIG. 5B depicts a block diagram illustrating the hardware configuration of a PDA in accordance with a preferred embodiment of the present invention;

FIG. 6 depicts a flowchart illustrating the process of issuing an electronic identification document in accordance with the present invention;

FIG. 7 depicts a pictorial diagram illustrating an ePassport with an authorization seal in accordance with the present invention;

FIG. 8 depicts a pictorial diagram illustrating the identification data content of an ePassport in accordance with the present invention;

FIG. 9 depicts a pictorial diagram illustrating the itinerary data content of an ePassport in accordance with the present invention;

FIG. 10 depicts a flowchart illustrating the process of verifying and updating an ePassport in accordance with the present invention; and

FIG. 11 depicts a flowchart illustrating the process of validating the user of an ePassport in accordance with the present invention.

### DETAILED DESCRIPTION OF THE PREFERRED EMBODIMENT

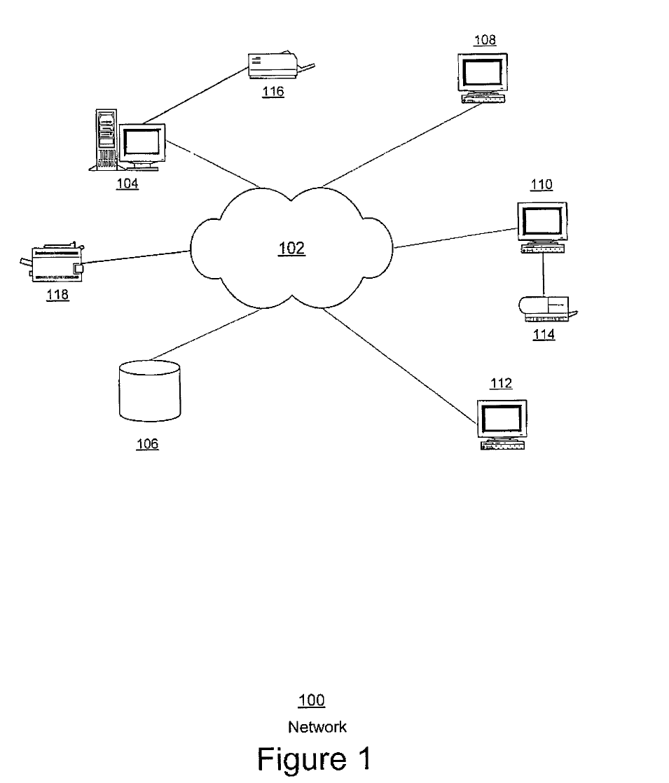

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 also includes printers 114, 116, and 118. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

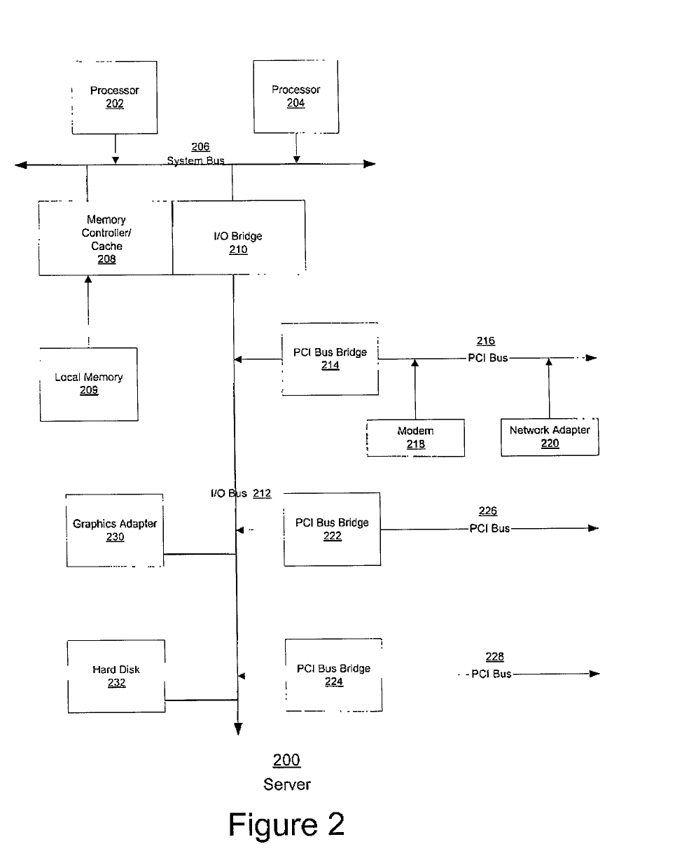

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly. Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, N.Y., running the Advanced Interactive Executive (AIX) operating system.

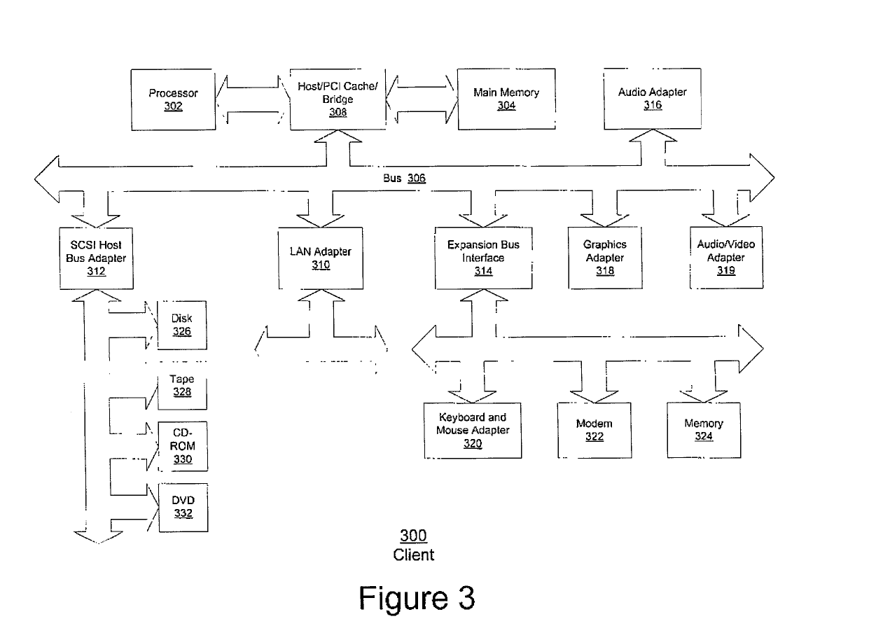

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, CD-ROM drive 330, and DVD drive 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

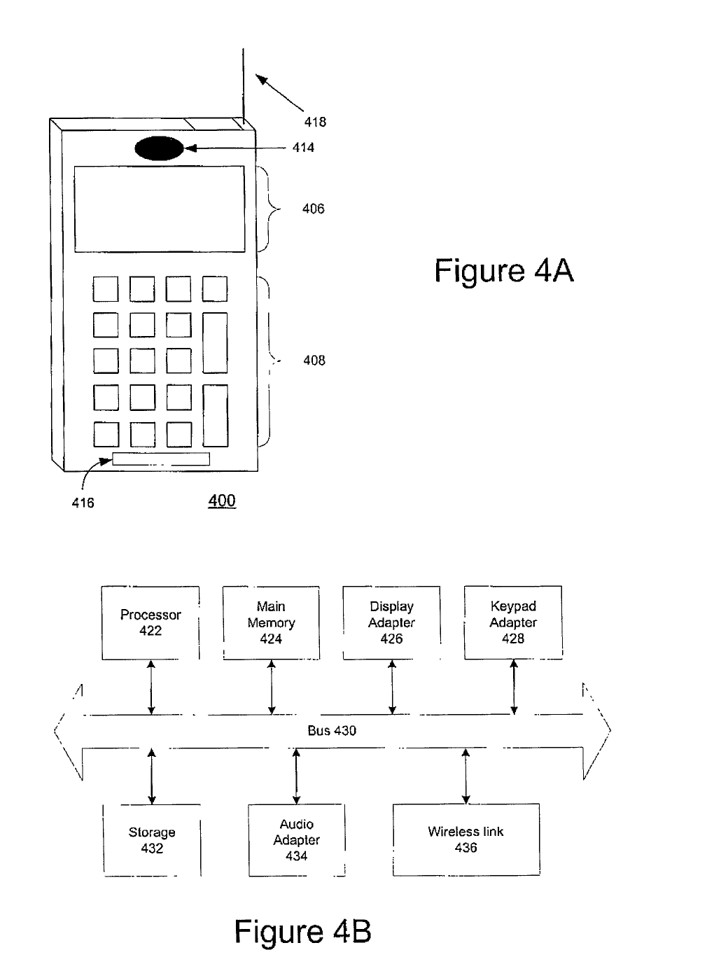

With reference now to FIG. 4A, a diagram illustrating a mobile phone is depicted in accordance with a preferred embodiment of the present invention. Mobile phone 400 includes a display 406 for presenting textual and graphical information. Display 406 may be a known display device, such as a liquid crystal display (LCD) device.

Mobile phone 400 may also include keypad 408, speaker 414, and microphone 416. The keypad may be used to enter, for example, telephone numbers, user identification information, and commands for interacting with the interface. Audio feedback may be presented via speaker 414. In addition to normal voice conversation, feedback may include other information, for example, location. And microphone 416 can be used not only for voice conversation, but for entering specific voice commands for voice actuated functions.

Mobile phone 400 also includes antenna 418, which is necessary for establishing wireless communication links with remote transmitting towers.

Turning now to FIG. 4B, a block diagram illustrating the hardware configuration of mobile phone 400 is shown in accordance with a preferred embodiment of the present invention. FIG. 4B illustrates the increasing sophistication of modern mobile phone designs.

Mobile phone 400 employs bus architecture. Processor 422 and main memory 424 are connected to bus 430. Display adapter 426, keypad adapter 428, storage 432, and audio adapter 434 are also connected to bus 430. Mobile phone 400 also includes wireless link 436 connected to bus 430. Those of ordinary skill in the art will appreciate that the hardware in FIG. 4B may vary depending on the implementation. Other internal hardware or peripheral devices may be used in addition to or in place of the hardware depicted in FIG. 4B.

Mobile phone 400 might rely on Wireless Application Protocol (WAP) for facilitating communications. WAP is a standard for providing wireless phones, pagers and other handheld devices with secure access to e-mail and text-based Web pages. WAP provides a complete environment for wireless applications that includes a wireless counterpart of TCP/IP and a framework for telephony integration such as call control and phone book access. WAP features the Wireless Markup Language (WML), which was derived from Phone.com's HDML and is a streamlined version of HTML for small screen displays. It also uses WMLScript, a compact JavaScript-like language that runs in limited memory. WAP also supports handheld input methods such as a keypad and voice recognition. Independent of the air interface, WAP runs over all the major wireless networks in place. It is also device independent, requiring only a minimum functionality in the unit so that it can be used with a myriad of phones and handheld devices.

The depicted example in FIG. 4B and above-described examples are not meant to imply architectural limitations.

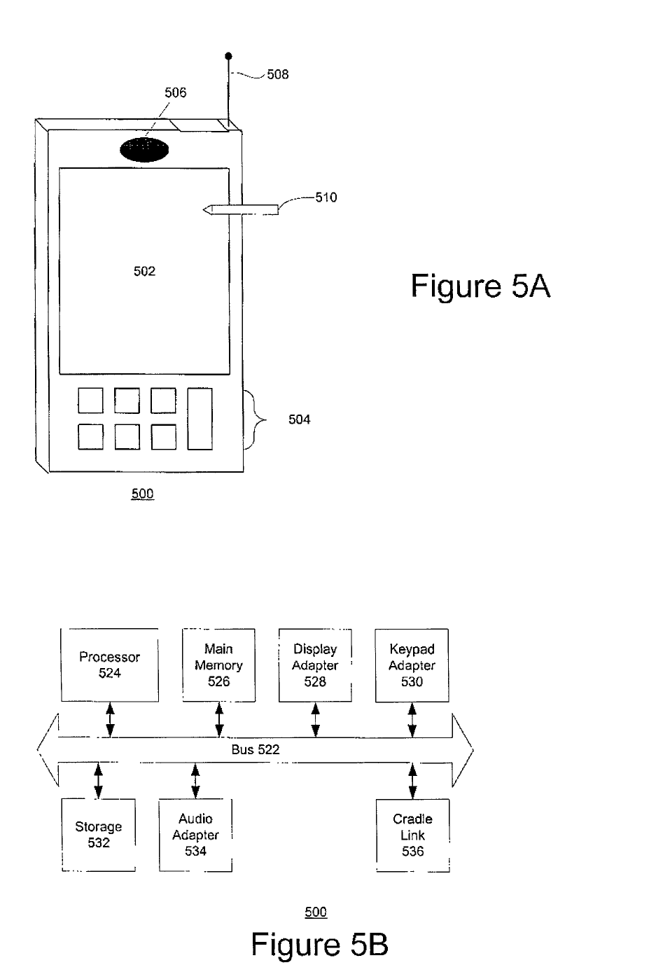

With reference now to FIG. 5A, a diagram of a client in the form of a personal digital assistant (PDA) is depicted in accordance with a preferred embodiment of the present invention. PDA 500 includes a display 502 for presenting textual and graphical information. Display 502 may be a known display device, such as a liquid crystal display (LCD) device. The display may be used to present a map or directions, calendar information, a telephone directory, or an electronic mail message. In these examples, screen 502 may receive user input using an input device such as, for example, stylus 510.

PDA 500 may also include keypad 504, speaker 506, and antenna 508. Keypad 504 may be used to receive user input in addition to using screen 502. Speaker 506 provides a mechanism for audio output, such as presentation of an audio file. Antenna 508 provides a mechanism used in establishing a wireless communications link between PDA 500 and a network, such as network 100 in FIG. 1.

PDA 500 also preferably includes a graphical user interface that may be implemented by means of systems software residing in computer readable media in operation within PDA 500.

Turning now to FIG. 5B, a block diagram illustrating the hardware configuration of PDA 500 is shown in accordance with a preferred embodiment of the present invention. PDA 500 is an example of a PDA in which code or instructions implementing the processes of the present invention may be located. PDA 500 includes a bus 522 to which processor 524 and main memory 526 are connected. Display adapter 528, keypad adapter 530, storage 532, and audio adapter 534 also are connected to bus 522. Cradle link 536 provides a mechanism to connect PDA 500 to a cradle used in synchronizing data in PDA 500 with another data processing system. Further, display adapter 528 also includes a mechanism to receive user input from a stylus when a touch screen display is employed.

An operating system runs on processor 524 and is used to coordinate and provide control of various components within PDA 500 in FIG. 5B. The operating system may be, for example, a commercially available operating system such as Windows CE, which is available from Microsoft Corporation. Instructions for the operating system and applications or programs are located on storage devices, such as storage 532, and may be loaded into main memory 526 for execution by processor 524.

Those of ordinary skill in the art will appreciate that the hardware in FIG. 5B may vary depending on the implementation. Other internal hardware or peripheral devices, such as flash ROM (or equivalent nonvolatile memory) or optical disk drives and the like, may be used in addition to or in place of the hardware depicted in FIG. 5B.

Mobile phone 400 and PDA 500 are simply examples of pervasive computing devices which may be used with the present invention. Other pervasive computing devices which are capable of downloading, storing, and uploading information may be used to implement the present invention.

The present invention provides a secure, digital format for electronic passports (ePassports), electronic visas (eVisas), and other electronic identification documents such as driver's license. These electronic documents can be used in place of traditional paper passports and visas. The electronic documents can be downloaded through pervasive computing devices and used with authentication and validation mechanisms.

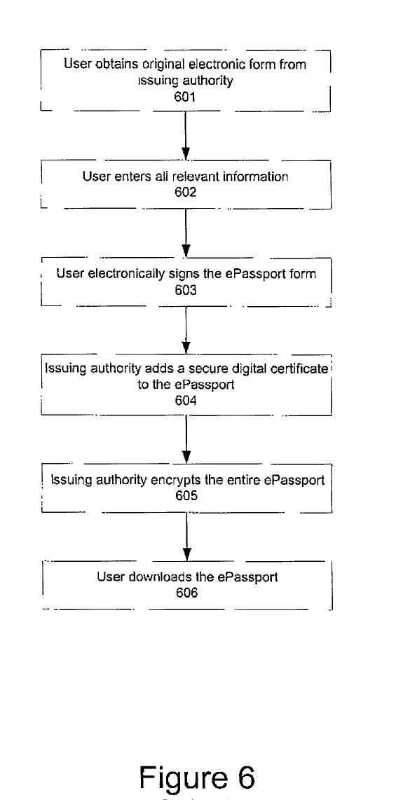

Referring to FIG. 6, a flowchart illustrating the process of issuing an electronic identification document is depicted in accordance with the present invention. The person seeking an electronic identification document, e.g. ePassport, first obtains an original electronic form from the issuing authority (step 601). The form will have a unique serial number from the issuing authority and a digital watermark to detect forgeries. A digital watermark is a pattern of bits embedded into a file, which is used to identify the source of illegal copies. For example, if a digital watermark is placed into an ePassport, then all copies of that document are uniquely identified. The digital watermark provides a trace for the issuing and certifying authorities.

The user then enters all relevant information into the electronic form (step 602). The information will likely be the similar to that used for paper passports: name, address, date of birth, Social Security Number, as well as other identifying information. After the personal information is entered, the user electronically signs the form (step 603). An electronic signature ensures that the ePassport originated with the proper party and that the document has not been tampered with. An electronic signature is equivalent of a handwritten signature. Electronic signature software binds the user's signature, or other mark, to the electronic document. Electronic signature software can also detect the alteration of an electronically-signed file any time in the future.

After the user signs the ePassport, the issuing authority adds a secure digital certificate to the document (step 604). The digital certificate verifies that the document was indeed issued by the proper issuing authority. The issuing authority then encrypts the entire ePassport (step 605).

The user is now able to download the ePassport (step 606). The ePassport may be stored and carried in any pervasive computing device. Examples of pervasive computing devices include PDAs, such as PDA 500, cellular phones, smart phones, and palm pilots. The ePassport may also be stored in a secret user account on a server or personal computer, and then downloaded to pervasive computing devices as needed.

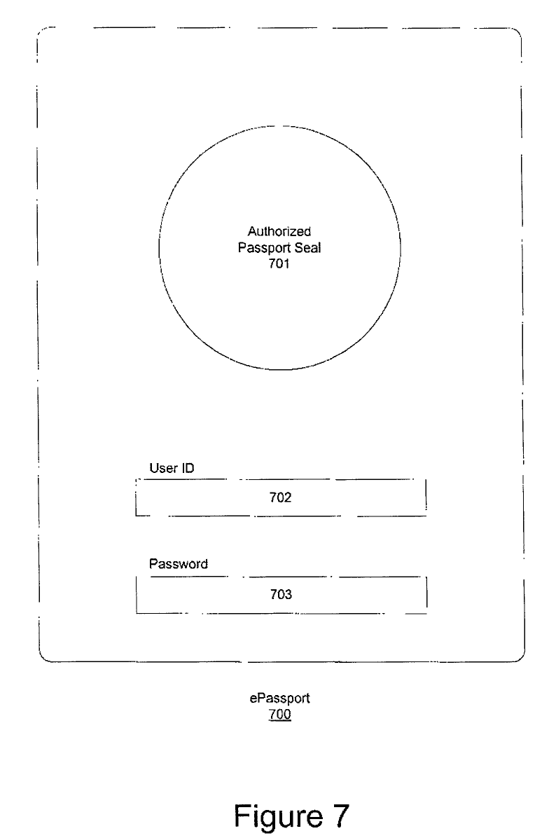

Referring to FIG. 7, a pictorial diagram illustrating an ePassport with an authorization seal is depicted in accordance with the present invention. The view in FIG. 7 is one of several that a verifying authority may choose, depending on what type of information in which the authority is interested. In FIG. 7, a view of the authorization seal 701 from the issuing authority is displayed along with a user ID field 702 and a password field 703. This data can be used to verify the authenticity of the ePassport and validate the user of the ePassport, as explained below.

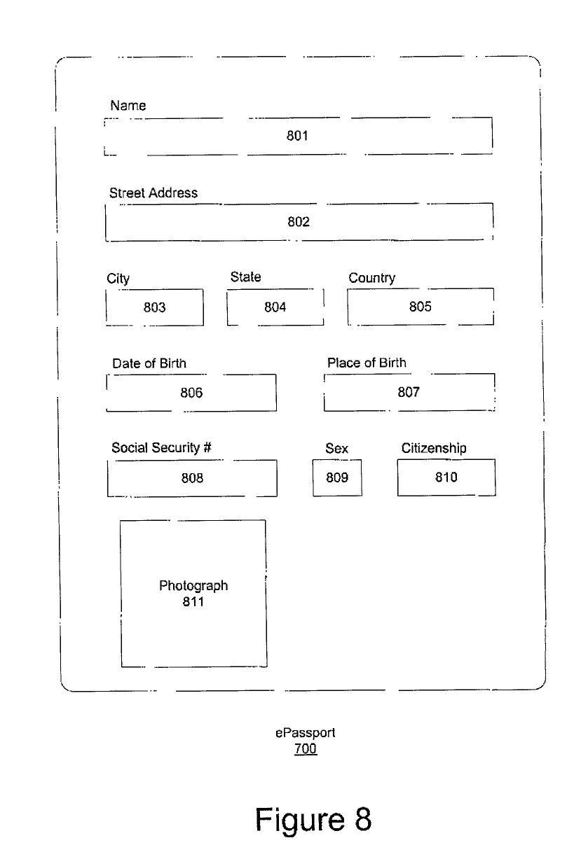

Referring to FIG. 8, a pictorial diagram illustrating the identification data content of an ePassport is depicted in accordance with the present invention. FIG. 8 presents another view of ePassport 700, displaying personal identification information including name 801, address 802, citizenship 810, and identifying photograph 811, similar to a paper passport.

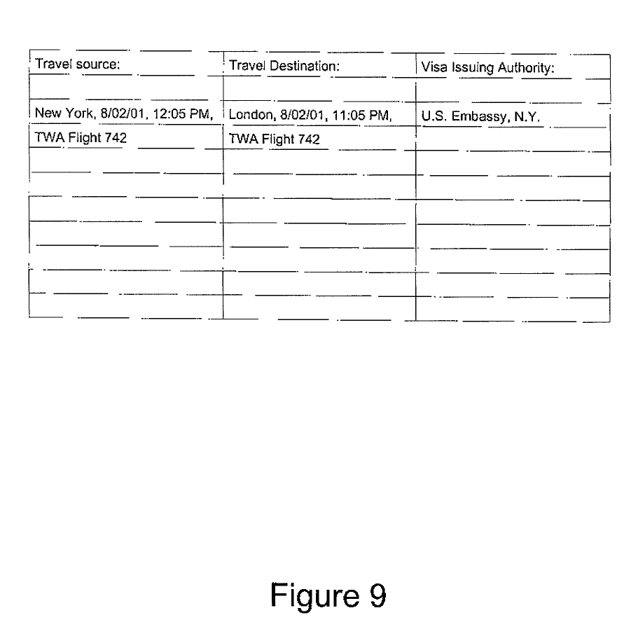

Referring to FIG. 9, a pictorial diagram illustrating the itinerary data content of an ePassport is depicted in accordance with the present invention. As with FIGS. 7 and 8, FIG. 9 depicts another view of ePassport 700 which authorities might choose. The itinerary information might be used by authorities when attaching eVisas to ePassport 700, rather than for authentication.

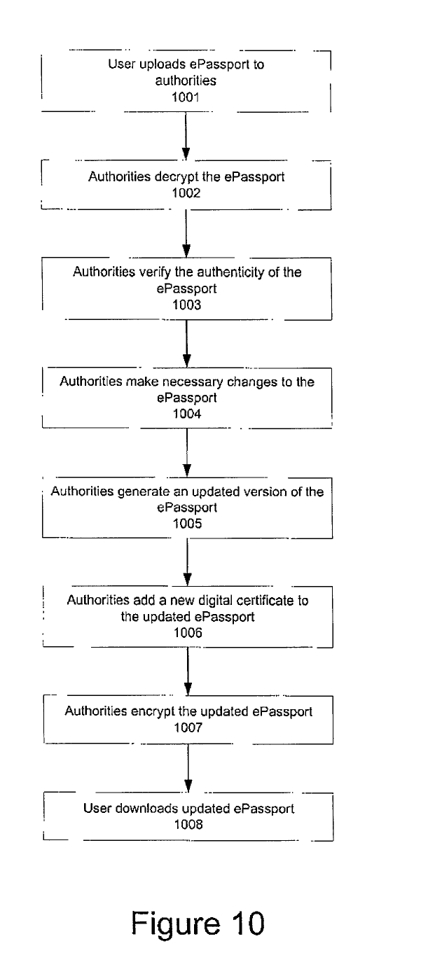

Referring to FIG. 10, a flowchart illustrating the process of verifying and updating an ePassport is depicted in accordance with the present invention. When the user is required to show his or her passport at appropriate checkpoints, for example when passing through customs, the user uploads the ePassport from the computing device in which it is stored (e.g. PDA) to the authorities' verification mechanism (step 1001). The upload may be accomplished by means of Bluetooth or similar protocol. Bluetooth is an open protocol for short-range transmission of digital data between mobile devices (e.g. PDA and mobile phones) and desktop devices, such as those used by checkpoint authorities. Bluetooth supports both point-to-point and multipoint applications.

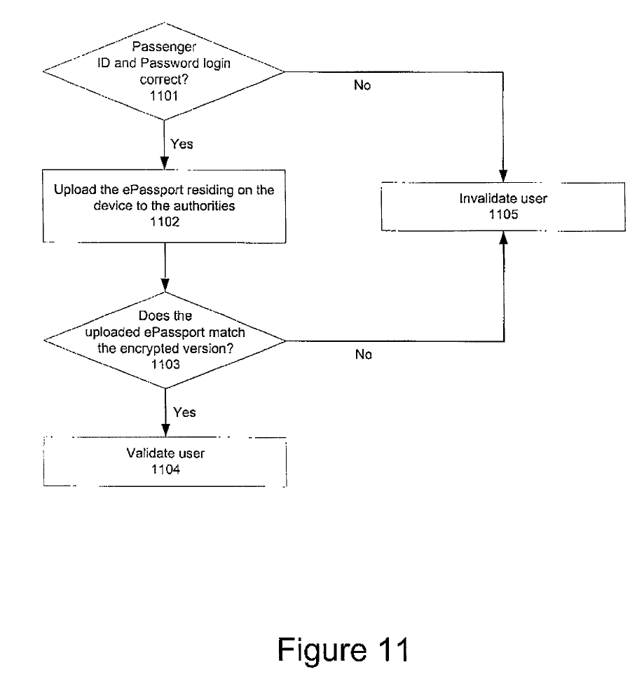

The authorities use their private keys to decrypt the ePassport (step 1002), and verify the authenticity of the ePassport by means of the user's electronic signature and the digital certificate attached to the ePassport (step 1003). This process is explained in more detail in FIG. 11.

The authorities may then make necessary changes to the ePassport (step 1004). An obvious change is the addition of entry and exit information (i.e. eVisas). Such information can be attached directly to the ePassport. After the necessary changes and additions have been made, the authorities generate an updated version of the ePassport which incorporates these changes (step 1005). A new digital certificate may also be added to the updated ePassport (step 1006). The updated ePassport is then encrypted (step 1007) and downloaded back to the users computing device (step 1008).

Referring now to FIG. 11, a flowchart illustrating the process of validating the user of an ePassport is depicted in accordance with the present invention. The user begins by entering a passenger (user) ID and password, which are verified by the ePassport itself (step 1101). For example, the ID and password might be entered into ID field 702 and password field 703 depicted in FIG. 7. If the ID and password login is not correct, the user is invalidated (step 1105). If the login is correct, the user may then upload the ePassport from the pervasive computing device to the authorities (step 1102).

Once the ePassport has been uploaded, the authorities may then validate the uploaded ePassport by decrypting it and determining if the uploaded ePassport matches a non-encrypted version of the ePassport residing on the authorities' repository (step 1103). If the authority validating the ePassport is also the issuing authority, the original non-encrypted version of the ePassport, with the proper electronic signature and digital certificate, will be stored in the authorities' repository. In the case of a foreign customs authority, the original non-encrypted version of the ePassport will have to be obtained by contacting a server of the issuing authority. Of course, the ability to access the foreign server depends upon the degree of reciprocity existing between the respective certifying authorities.

If the ePassports do not match, then the user is invalidated (step 1105). If the ePassports do match, the user is validated (step 1104). In this way, the process illustrated in FIG. 11 provides two levels of verification: first, when the user logs in to access the ePassport, and second, when the authorities verify the encryption keys, after the ePassport is uploaded.

The present invention also makes it easier for users to renew documents such as passports. Users may automatically renew their ePassports electronically at set time intervals, rather than physically going to a passport office to renew the passport.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for creating an electronic identification document, the method comprising:
providing an electronic document to a user, wherein the electronic document contains input fields for personal identification information;
receiving the user's personal identification information in the input fields of the electronic document;
receiving an electronic signature from the user, and attaching the electronic signature to the electronic document;
adding an electronic certificate to the electronic document;
encrypting the electronic document; and
uploading the electronic document to a pervasive computing device;
wherein the electronic document is a legally valid form of identification.

2. The method according to claim 1, wherein the electronic document is a passport.

3. The method according to claim 1, wherein the electronic document contains a unique serial number from an issuing authority.

4. The method according to claims 1, wherein the electronic document contains a digital watermark created by an issuing authority.

5. The method according to claim 1, wherein the electronic document contains at least one of the following items of personal information:
name;
home address;
date of birth;
country of citizenship; and
social security number.

6. The method according to claim 1, wherein the pervasive computing device may comprise any of the following:
personal digital assistant;
laptop computer;
mobile phone;
smart phone; and
palm pilot.

7. The method according to claim 1, wherein the electronic document is renewed automatically at set time intervals.

8. A method for verifying the authenticity of an electronic identification document, the method comprising:
downloading the electronic document from a pervasive computing device;
decrypting the electronic document;
validating a digital certificate attached to the electronic document;
verifying the authenticity of an electronic signature attached to the electronic document;
encrypting the electronic document; and
uploading the electronic document back to the pervasive computing device;
wherein the electronic document is a legally valid form of identification.

9. The method according to claim 8, wherein the electronic document is a passport.

10. The method according to claim 8, wherein the electronic document contains a unique serial number from an issuing authority.

11. The method according to claims 8, wherein the electronic document contains a digital watermark created by an issuing authority.

12. The method according to claim 8, wherein the electronic document contains at least one of the following items of personal information:
name;
home address;
date of birth;
country of citizenship; and
social security number.

13. The method according to claim 8, further comprising changing information contained in the electronic document.

14. The method according to claim 8, further comprising attaching new information to the electronic document.

15. The method according to claim 14, wherein the information attached to the electronic document is a visa.

16. The method according to claim 8, further comprising attaching a new digital certificate to the electronic document.

17. The method according to claim 8, wherein the electronic document is uploaded via the Bluetooth protocol.

18. The method according to claim 8, wherein the pervasive computing device may comprise any of the following:
personal digital assistant;
laptop computer;
mobile phone;
smart phone; and
palm pilot.

19. A method for creating an electronic identification document, the method comprising:
receiving an electronic document, wherein the electronic document contains input fields for personal identification information;
entering personal identification information in the input fields of the electronic document;
entering an electronic signature, wherein the electronic signature is attached to the electronic document; and
downloading the electronic document to a pervasive computing device, wherein the electronic document is encrypted and includes an electronic certificate;
wherein the electronic document is a legally valid form of identification.

20. The method according to claim 19, further comprising:
uploading the electronic document from the pervasive computing device.

21. A computer program product in a computer readable medium for use in a data processing system, for creating an electronic identification document, the computer program product comprising:
instructions for providing an electronic document to a user, wherein the electronic document contains input fields for personal identification information;
instructions for receiving the user's personal identification information in the input fields of the electronic document;
instructions for receiving an electronic signature from the user, and attaching the electronic signature to the electronic document;
instructions for adding an electronic certificate to the electronic document;
instructions for encrypting the electronic document; and
instructions for uploading the electronic document to a pervasive computing device;
wherein the electronic document is a legally valid form of identification.

22. A computer program product in a computer readable medium for use in a data processing system, for verifying the authenticity of an electronic identification document, the computer program product comprising:
instructions for downloading the electronic document from a pervasive computing device;
instructions for decrypting the electronic document;
instructions for validating a digital certificate attached to the electronic document;
instructions for verifying the authenticity of an electronic signature attached to the electronic document;
instructions for encrypting the electronic document; and
instructions for uploading the electronic document back to the pervasive computing device;
instructions for wherein the electronic document is a legally valid form of identification.

23. A computer program product in a computer readable medium for use in a data processing system, for creating an electronic identification document, the computer program product comprising:
instructions for receiving an electronic document, wherein the electronic document contains input fields for personal identification information;
instructions for entering personal identification information in the input fields of the electronic document;
instructions for entering an electronic signature, wherein the electronic signature is attached to the electronic document; and
instructions for downloading the electronic document to a pervasive computing device, wherein the electronic document is encrypted and includes an electronic certificate;
wherein the electronic document is a legally valid form of identification.

24. A system for creating an electronic identification document, the system comprising:
a first communication component which provides an electronic document to a user, wherein the electronic document contains input fields for personal identification information;
a first receiving component which receives the user's personal identification information in the input fields of the electronic document;
a second receiving component which receives an electronic signature from the user, and attaching the electronic signature to the electronic document;
a register which adds an electronic certificate to the electronic document;
an encrypting component which encrypts the electronic document; and
a second communication component which uploads the electronic document to a pervasive computing device;
wherein the electronic document is a legally valid form of identification.

25. A system for verifying the authenticity of an electronic identification document, the method comprising:
a first communication component which downloads the electronic document from a pervasive computing device;
a decrypting component which decrypts the electronic document;
a validation component which validates a digital certificate attached to the electronic document;
a verification component which verifies the authenticity of an electronic signature attached to the electronic document;
an encrypting component which encrypts the electronic document; and
a second communication component which uploads the electronic document back to the pervasive computing device;
wherein the electronic document is a legally valid form of identification.

26. A system for creating an electronic identification document, the system comprising:
a receiving mechanism which receives an electronic document, wherein the electronic document contains input fields for personal identification information;
a first input component which enters personal identification information in the input fields of the electronic document;
a second input component which enters an electronic signature, wherein the electronic signature is attached to the electronic document; and
a downloading mechanism which downloads the electronic document to a pervasive computing device, wherein the electronic document is encrypted and includes an electronic certificate;
wherein the electronic document is a legally valid form of identification.
